(19) United States
(12) Patent Application Publication
(10) Pub. No.: US 2024/0401220 A1
(43) Pub. Date: Dec. 5, 2024

(54) SEALING SOLUTION KIT, TWO-STEP SEALING METHOD USING THE SAME AND ARTICLE

(71) Applicant: Henkel AG & Co. KGaA, Duesseldorf (DE)

(72) Inventors: Xin Jiang, Shanghai (CN); Yi Liu, Shanghai (CN); Yang Li, Shanghai (CN)

(21) Appl. No.: 18/748,621

(22) Filed: Jun. 20, 2024

Related U.S. Application Data
(63) Continuation of application No. PCT/CN2021/140318, filed on Dec. 22, 2021.

(51) Int. Cl. C25D 11/24; C09D 1/00; C09D 5/08; C09D 171/02; C25D 5/44; C25D 11/20

(52) U.S. Cl. CPC C25D 11/246; C09D 1/00; C09D 5/08; C09D 171/02; C25D 5/44; C25D 11/20

(57) ABSTRACT

This invention relates to a sealing solution kit comprises: a medium temperature sealing solution; and a high temperature sealing solution. This invention also provides a method for sealing an anodized aluminum alloy surface by using the sealing solution kit, an article which has at least one portion that comprises side treated surface by the sealing solution kit demonstrates improved corrosion resistance and vehicles comprising said surface treated articles as automotive parts. The vehicles with said surface treated articles can endure harsh environmental conditions.

### TECHNICAL FIELD

This invention relates to a sealing solution kit comprising a medium temperature sealing solution and a high temperature sealing solution and a two-step sealing method using the sealing solution kit. An article comprising anodized aluminum alloy surface treated by the sealing solution kit demonstrates improved corrosion resistance property.

### BACKGROUND OF THE INVENTION

Anodization of aluminum alloy is generally used to improve the corrosion resistance and mechanical properties of the aluminum alloy. A uniform, transparent, and highly porous aluminum oxide film forms on the surface of aluminum alloy after anodized in a sulfuric acid-based electrolyte. The pores on the film, however, almost extend to the surface of the aluminum alloy making the film insufficient to protect the aluminum alloy from chemical corrosions. As a result, the aluminum oxide films need to be further sealed.

The most commonly used sealing processes are classified into high, medium and low temperature treatments according to different operation temperatures. High temperature treatment using steam and hot water is performed at a temperature ranging from higher than 80° C. to no higher than the boiling point of water, and the high temperature treated aluminum oxide film is hydrated to form aluminum hydroxide gel, pseudo boehmite, and crystalline boehmite which swells and effectively seals pores. Medium temperature treatment is performed at a temperature ranging from 50 to 80° C. and utilizes solutions of hydrolysable metal salts, such as nickel acetate and cobalt acetate, for sealing. The material which dissolves from the oxide layer into warm water reacts with metal ions to produce a solid material and seals the pores. Low temperature treatment is performed at a temperature ranging from room temperature to less than 50° C. and utilizes metal fluorides, such as nickel fluoride, for sealing. The fluoride ions dissolve aluminum oxide film and re-deposit as a nickel aluminum fluoride complex to seal the pores.

Multi-step sealing process is also adapted by some prior arts which combines treatments using different sealing solutions together to achieve an improved sealing of the aluminum oxide film.

Anodized aluminum alloys for exterior applications such as decorative automotive parts are frequent exposed to harsh environmental corrosions, such as moisture, salt, and dirt. In addition, the widely used automotive cleaning devices usually clean vehicles in highly alkaline media. Contact of sealed aluminum surfaces with highly alkaline media takes place, for example for automotive window frame trims and luggage racks that are manufactured from aluminum materials, in car washes in which alkaline cleaners with pH values in the range of 11.5-13.5 are applied onto the cars. The anodized aluminum alloys of automotive parts treated by the existing sealing solutions and processes cannot meet with the high standard of corrosion resistance required by automotive industry. Therefore, there is a need to develop a sealing solution and sealing process which is able to provide a high quality sealed anodized aluminum oxide film with enhanced corrosion resistance, particularly good acid and alkali resistance performance, meanwhile the sealing process does not affect the appearance of finished articles and prevents the undesirable tarnishing of the aluminum surface and maintaining the gloss of aluminum substrates. In addition, sealing solutions need better storage stability.

### SUMMARY OF THE INVENTION

The present invention relates to a sealing solution kit comprises: a medium temperature sealing solution; and a high temperature sealing solution; wherein the medium temperature sealing solution, based on the total volume of the medium temperature sealing solution, comprising: water; 0.6 to 2.6 g/L of fluoride ions; 2.0 to 5.0 g/L of a first ion selected from a group consisting of nickel ions, cobalt ions, chromium ions, cadmium ions and mixtures thereof; 0.03 to 1.3 g/L of a second ion selected from the group consisting of zirconium ions, titanium ions, silicon-containing ions, and mixtures thereof; an effective amount of surfactant; the high temperature sealing solution comprising, based on the total volume of the high temperature sealing solution, water and 0.1 g/L to 100 g/L of water-soluble polymer, the water-soluble polymer having a weight-average molecular weight of 5,000 g/mol to 400,000 g/mol, and the water-soluble polymer being selected from the group consisting of poly(meth)acrylic acid and its derivatives, polyether and its derivatives, polyamide and its derivatives, poly(sulfonic acid) and its derivatives and mixtures thereof.

The present invention also relates to a method for sealing an anodized aluminum alloy surface by using the sealing solution kit according to current invention, comprising steps of: a) contacting said surface with the medium temperature sealing solution at a temperature from 50 to 80° C., or 50 to 95° C. and a pH value of 4.5 to 7; b) contacting said surface with the high temperature sealing solution at a temperature from greater than 80° C. to no less than 100° C. and a pH value of 7 to 12, or a pH value of greater than 7 to 12, and c) drying the liquid layer formed in operation (a) and (b) to form a treated surface.

The present invention also relates to an article which has at least one portion that comprises side treated surface of present invention. The article which is surface treated by said sealing solution kit of the present invention, or by the sealing method of the present invention. The surface treated article has excellent corrosion resistance demonstrated by dye spot test (grade 0 and grade 1 are allowable) and corrosion resistance test (no slight appearance changes after pH 1+13.5 test, grade 2 to grade 5 are not acceptable).

The present invention is also related to vehicles comprising said surface treated articles as automotive parts. The vehicles with said surface treated articles can endure harsh environmental conditions.

### BRIEF DESCRIPTION OF THE DRAWINGS

FIG. 1 shows the grade classification of dye spot testing results.

FIG. 2 shows numerical grade ranking and corresponding appearance for assessing anti-acid & alkali test performance in corrosion testing of sealed anodized aluminum alloy samples.

### DETAILED DESCRIPTION OF THE INVENTION

In the following passages the present invention is described in more detail. Each aspect so described may be combined with any other aspect or aspects unless clearly indicated to the contrary. In particularly, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise. For example, reference to “an ion” encompasses embodiments having one, two or more ions. As used in this specification and the appended claims, the term “or” is generally employed in its sense including “and/or” unless the content clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The recitation of numerical end points includes all numbers and fractions subsumed within the respective ranges, as well as the recited end points.

Unless otherwise defined, all terms used in the disclosing the invention, including technical and scientific terms, have the meaning as commonly understood by one of the ordinary skills in the art to which this invention belongs to. By means of further guidance, term definitions are included to better appreciate the teaching of the present invention.

In the context of this disclosure, several terms shall be utilized.

The term “medium temperature” of this disclosure in “medium temperature sealing solution” refers to a temperature which is from 50° C. to 95° C. Medium temperature sealing of this disclosure is performed at a temperature ranging from 50 to 95° C., which can be performed on a bigger range than 50 to 80° C.

The term “high temperature” in “high temperature sealing solution” refers to a temperature which is from higher than 80° C. to no higher than 100° C.

The term “water-soluble” means that the relevant component or ingredient of the composition can be dissolved in the aqueous phase on the molecular level, and the terms “solution”, “soluble”, “homogeneous”, and the like are to be understood as including not only true equilibrium solutions or homogeneity but also dispersions.

The term “polymer” is used herein consistent with its common usage in chemistry. Polymers are composed of many repeated subunits. The term “polymer” is used to describe the resultant material formed from a polymerization reaction.

Specification of materials in ionic form additionally implies the presence of sufficient counterions to produce electrical neutrality for the composition as a whole (any counterions thus implicitly specified should preferably be selected from among other constituents explicitly specified in ionic form, to the extent possible; otherwise, such counterions may be freely selected, except for avoiding counterions that act adversely to the objects of the invention).

The term “aluminum” as used herein includes both the pure metal and alloys, which are designated hereinafter simply as “aluminum”, unless the context requires otherwise.

### Sealing Solution Kit

The present invention relates to a sealing solution kit comprises: a medium temperature sealing solution; and a high temperature sealing solution.

The medium temperature sealing solution, based on the total volume of the medium temperature sealing solution, comprising: water; 0.6 to 2.6 g/L of fluoride ions; 2.0 to 5.0 g/L of a first ion selected from a group consisting of nickel ions, cobalt ions, chromium ions, cadmium ions and mixtures thereof; 0.03 to 1.3 g/L of a second ion selected from the group consisting of zirconium ions, titanium ions, silicon-containing ions, and mixtures thereof; an effective amount of surfactant.

The high temperature sealing solution comprising, based on the total volume of the high temperature sealing solution, water and 0.1 g/L to 100 g/L of water-soluble polymer, the water-soluble polymer having a weight-average molecular weight of 5,000 g/mol to 400,000 g/mol, and the water-soluble polymer being selected from the group consisting of poly(meth)acrylic acid and its derivatives, polyether and its derivatives, polyamide and its derivatives, poly(sulfonic acid) and its derivatives and mixtures thereof.

### Water-Soluble Polymer

The high temperature sealing solution of the present invention comprises at least one water-soluble polymer having a weight-average molecular weight of 5,000 g/mol to 400,000 g/mol, and the water-soluble polymer being selected from the group consisting of poly(meth)acrylic acid and its derivatives, polyether and its derivatives, polyamide and its derivatives, poly(sulfonic acid) and its derivatives and mixtures thereof. The water-soluble polymer of the present invention can be used alone or in any combination.

In some embodiments of the present invention, the concentration of the water-soluble polymer in the high temperature sealing solution is preferably from 0.1 g/L to 100 g/L, or 0.1 g/L to 50 g/L, or 0.1 g/L to 20 g/L. The lower limit concentration of the water-soluble polymer in the high temperature sealing solution is 0.1 g/L, or 0.15 g/L, or 0.2 g/L, or 0.5 g/L, or 1.0 g/L, or 1.2 g/L, or 2.0 g/L, or 5.0 g/L, or 10.0 g/L. The upper limit concentration of the fluoride ions is 100.0 g/L, or 80.0 g/L, or 50.0 g/L, or 30.0 g/L, or 20.0 g/L, or 18.0 g/L, or 15.0 g/L.

The term “poly(meth)acrylic acid” of the present invention refers to polyacrylic acid and/or polymethacrylic acid. The poly(meth)acrylic acid derivatives refer to poly((methyl)acrylic acid), poly(acrylic acid) sodium salt, poly(methacrylic acid) ammonium salt, poly(vinyl acetate), acrylic acid-2-acrylamino-2-methylpropane sulfonic acid copolymer and other acrylic polymer, etc. The poly(meth)acrylic acid and its derivatives have a weight-average molecular weight of 5,000 g/mol to 100,000 g/mol, or 5,000 g/mol to 80,000 g/mol.

The term “polyether” of the present invention refers to a group of hydrocarbons having more than one ether group and may optionally comprise other functional groups such as hydroxyl or amino groups. The polyether derivatives comprise poly(ethylene oxide), polyethylene glycol, etc. The polyether and its derivatives have a weight-average molecular weight of 80,000 g/mol to 400,000 g/mol, or 100,000 g/mol to 300,000 g/mol.

The term “polyamide” of the present invention refers to a group of polymers that is made of continuous units in the molecular linkage that are bonded by amide groups. The polyamide derivatives comprise polyacrylamide, poly(N-vinyl acetamide) and other amide polymers. The polyamide and its derivatives have a weight-average molecular weight of 8,000 g/mol to 100,000 g/mol, or 10,000 g/mol to 80,000 g/mol, or 10,000 g/mol to 70,000 g/mol.

The one or more “polysulfonic acids” of the present invention include but are not limited to alkyl and/or aryl polysulfonic acids such as methanedisulfonic acid, ethanedisulfonic acid, propanedisulfonic acid and 1,3,6 naphthalene trisulfonic acid among other. Polysulfonic acid derivatives comprise poly((vinyl)sulfonic acid) sodium salt, polyacrylamidomethylpropane sulfonic acid, poly(styrenesulfonic acid), poly(styrenesulfonic acid) sodium salt and other sulfonic polymer. The poly(sulfonic acid) and its derivatives have a weight-average molecular weight of 80,000 g/mol to 400,000 g/mol, or 100,000 g/mol to 300,000 g/mol.

The above water-soluble polymers can be used alone or in any combinations.

Examples of commercially available water-soluble polymers are, for example, polyacrylic acid from Shanghai Zhaode, POLYOX WSR N-10 from Dow, and PA 610 from Dupont.

### Water

The high temperature sealing solution of the present invention comprises water as solvent to dissolve all components to form the sealing solution. In some embodiments of the present invention, it is preferably to use deionized water as solvent.

### pH Value of the High Temperature Sealing Solution

The pH value of the high temperature sealing solution is 7 to 12, or greater than 7 to 12, or 7.1 to 12, or 8 to 11.5. The lower limit of pH value is 7.0, 7.1, or 7.2, or 7.5, or 7.8, or 8.0, or 8.2, or 8.5, or 9.0 g/L; the upper limit of pH value is 12, or 11.8, or 11.6, or 11.5, or 11.2, or 11. One or more optional pH-adjusting agents, including minor amounts of mineral acids, alkali components, and organic acids may be used to adjust the pH value to above desired operating pH value if needed. High temperature sealing solution with a neutral and a more preferred basic operating pH value will lead to a better anti corrosion result.

### First Ion(s)

The medium temperature solution according to the embodiment includes a first ion(s). The first ions are selected from nickel ions, cobalt ions, chromium ions, and cadmium ions. The first ions are selected from divalent nickel ions, divalent cobalt ions, tetravalent zirconium ions, and divalent cadmium ions. The concentration of the first ion in the medium temperature sealing solution is from 2.0 to 5.0 g/L, or from 2.1 to 5.0 g/L, or from 2.2 to 5.0 g/L, or from 2.4 to 5.0 g/L. The lower limit concentration of the first ions is 2.0 g/L, or 2.1 g/L, or 2.2 g/L, or 2.4 g/L, or 2.5 g/L, or 2.6 g/L, or 3.0 g/L; the upper limit concentration of the first ions is 5.0 g/L, or 4.9 g/L, or 4.5 g/L, or 4.2 g/L, or 3.5 g/L.

In some embodiments of the present invention, the first ion is preferably nickel ion, especially divalent nickel ions. The concentration of the nickel ion in the medium temperature sealing solution is from 2.0 to 5.0 g/L, or from 2.1 to 5.0 g/L, or from 2.2 to 5.0 g/L, or from 2.4 to 5.0 g/L. The lower limit concentration of the nickel ions is 2.0 g/L, or 2.1 g/L, or 2.2 g/L, or 2.3 g/L, or 2.4 g/L, or 2.5 g/L. The upper limit concentration of the nickel ions is 5.0 g/L, or 4.9 g/L, or 4.5 g/L, or 4.2 g/L, or 3.5 g/L.

The same first ion source may be supplied as a concentrated concentration of 10 g/L up to 25 g/L of the first ion ions.

The concentrated first ions may be diluted with deionized water to provide the medium temperature sealing solutions with a final 2 g/L to 5 g/L or other above listed preferred concentrations.

The first ion concentrations were determined from ICP-AES measurement. ICP-AES (VARIAN 710-ES) instrument equipped with Teflon™ injection system. ICP-AES standard: EPA3052. Standard solution with concentration of 0.1, 1, 5, and 10 ppm were injected to ICP-AES system in order to create the standard calibration curve, and then the samples were injected and analyzed. The samples were filtered with 0.22 μm filter first before injecting into ICP system.

Representative examples of the sources of the first ions include but are not limited to nickel salts (nickel salt hydrate), such as nickel fluoride, nickel acetate, nickel nitrate, nickel sulphate, nickel sulphamate, nickel carbonate and the like; cobalt salts (cobalt salt hydrate), such as cobalt fluoride, cobalt acetate, cobalt nitrate, cobalt sulphate, cobalt sulphamate, cobalt carbonate and the like; chromium salts (chromium salt hydrate), such as chromium fluoride, chromium acetate, chromium nitrate, chromium sulphate, chromium carbonate and the like; and cadmium salts (cadmium salt hydrate), such as cadmium acetate, cadmium nitrate, cadmium sulphate, and the like. Preferably, the sources of the first ions are selected from nickel fluoride, nickel acetate, nickel nitrate, nickel sulphate, nickel sulphamate, nickel carbonate, and any combination thereof. The sources of the first ions can be used alone or in any combination.

Examples of commercially available sources of the first ions are, for example, NiF₂·4H₂O from Sinopharm Chemical Reagent Co., Ltd. and Ni(CH₃COO)₂·4H₂O from Sinopharm Chemical Reagent Co., Ltd.

When Ni content is higher than 2 g/L for general room temperature sealing, sealed parts surface will be of slight green. It is surprisingly found that in medium temperature sealing solution, when the concentration of the first ion, especially Ni ion, is higher than 2.5 g/L, the medium temperature sealing solution has good anti-corrosion performance and the surface of sealed parts does not turn slight green.

### Fluoride Ion(s)

The medium temperature sealing solution according to the embodiment comprises free fluoride anions and fluorometallate anions. Free fluoride anions may be selected from nickel fluoride, potassium fluoride, sodium fluoride, sodium bifluoride, ammonium bifluoride and the others. Most preferably, nickel fluoride and potassium fluoride, sodium fluoride or ammonium bifluoride. The fluorometallate anions preferably are fluorosilicate (i.e., SiF₆²⁻), fluorotitanate (i.e., TiF₆²⁻) or fluorozirconate (i.e., ZrF₆²⁻), more preferably fluorotitanate or fluorozirconate, most preferably fluorozirconate. The cation for the fluorometallate anion may be selected from ions of group IA elements, or ammonium ions. Preferably the cation is K or H, most preferably H.

The concentration of the dissolved fluoride ion in the medium temperature sealing solution is from 0.6 to 2.6 g/L, or from 0.7 to 2.4 g/L, or from 1.2 to 2.4 g/L. The lower limit concentration of the fluoride ions is 0.6 g/L, or 0.7 g/L, or 0.8 g/L, or 1.0 g/L, or 1.1 g/L, or 1.2 g/L, or 1.4 g/L. The upper limit concentration of the fluoride ions is 2.7 g/L, or 2.6 g/L, or 2.4 g/L, or 2.3 g/L, or 2.1 g/L, or 2.0 g/L, or 1.8 g/L.

The ion concentrations were determined from Ion chromatography (IC) measurement. The experiments were carried out on a Dionex 1500 IC. Mobile phase: KOH aqueous solution; Column Set: Dionex AG11+ASHC-11; Column Temperature: 35° C.; Detector(s): Conductivity Cell; Flow Rate: 1 ml/min; Injection Volume: 25 μl; EGC Concentration: 30 mmol; Standards: multi-anions: 0.1-10.0 ppm; Run Time: 20 minutes per injection. Samples were neutralized and filtrated with solid phase extraction (SPE) columns (IC-RP) and 0.22 μm filter to remove almost all the organic contained and insoluble ashy in the samples. Then solutions were injected to IC system in order to create the standard calibration curves, and afterwards the replicates of diluted samples were injected into IC system and analyzed.

Representative examples of the sources of the fluoride ions include but are not limited to nickel fluoride, potassium fluoride, potassium bifluoride, sodium fluoride, sodium bifluoride, ammonium bifluoride and the like. Most preferably, nickel fluoride, potassium fluoride, sodium fluoride, ammonium bifluoride and combinations thereof. The sources of the fluoride ions can be used alone or in any combinations. Fluorine ions may be supplied as a concentrate with a concentration from 2 g/L up to 14 g/L, then diluted with deionized water to provide a desired concentration.

When fluoride ions content is higher than 1.2 g/L in traditional room temperature sealing solution, dust issue will appear. It is surprisingly found that when the concentration of the dissolved fluoride ion(s) is higher than 1.2 g/L in the medium temperature sealing solution of current disclosure, dust issue does not appear.

Examples of commercially available sources of the fluoride ions are, for example, NiF₂·4H₂O (≥98 wt. %) from Sinopharm Chemical Reagent Co., Ltd. Potassium fluoride (99 wt. %) from Shanghai Aladdin Bio-chemical Technology Co., Ltd.

### Second Ion(s)

The medium temperature sealing solution of the present invention comprises at least one second ion(s), which is selected from tetravalent zirconium ions, tetravalent titanium ions, and silicon-containing ions. The concentration of the second ion in the medium temperature sealing solution is from 0.03 to 1.3 g/L, preferably from 0.05 to 1.2 g/L, such as 0.1 g/L, or 0.4 g/L, 0.6 g/L, 1.0 g/L. Corrosion inhibitors zirconium ions and/or titanium ions and/or silicon-containing ions significantly increase final corrosion performance.

Representative examples of the sources of the second ions include but are not limited to zirconium salts, such as zirconium carbonate, zirconium nitrate, zirconium oxynitrate, ammonium zirconium carbonate, and the like; titanium salts, such as titanium carbonate, titanium nitrate, and the like; silicate, such as sodium silicate, potassium silicate, and the like. Zirconium/Titanium/Silicon based acids, such as hexafluorozirconic acid, hexafluorotitanic acid, hexafluorosilicic acid, and the like. The sources of the second ions can be used alone or in any combination.

Examples of commercially available sources of the second ions are, for example, Zr(NO₃)₄·5H₂O (99.5 wt. %, AR) from Sinopharm Chemical Reagent Co., Ltd. and H₂ZrF₆ (45 wt. %) from Beijing Wokai Biotechnology Co., Ltd.

In some embodiments of the present invention, the second ion is preferably zirconium ion, especially divalent zirconium ions. The concentration of the zirconium ion in the medium temperature sealing solution is from 0.03 to 1.3 g/L, or from 0.05 to 1.2 g/L, or from 0.1 to 1.2 g/L. The lower limit concentration of the zirconium ions is 0.03 g/L, or 0.04 g/L, or 0.05 g/L, or 0.08 g/L, or 0.1 g/L, or 0.2 g/L, or 0.3 g/L, or 0.4 g/L, or 0.5 g/L, or 0.6 g/L. The upper limit concentration of the nickel ions is 1.3 g/L, or 1.2 g/L, or 1.1 g/L, or 1.0 g/L.

The second ion concentrations were determined from ICP-AES measurement. It is tested on an ICP-AES (VARIAN 710-ES) instrument equipped with Teflon injection system. ICP-AES standard is EPA3052. Standard solution with concentration of 0.1, 1, 5, and 10 ppm were injected to ICP-AES system in order to create the standard calibration curve, and then the samples were injected and analyzed. The samples were filtered with 0.22 μm filter first before injecting into ICP system.

### Surfactant

The medium temperature sealing solution of the present invention comprises at least one surfactant which reduces the surface tension of the aluminum oxide film and allows sealing solution to enter into pores and further seal the aluminum oxide film. The surfactant of the present invention refers to any commonly used surfactants, and includes but is not limited to anionic surfactants, such as sulfonate, sulfate, phosphate ethers, carboxylates, and the like; non-ionic surfactants, such as alcohol ethoxylates, alcohol alkoxylates, alkylamine oxides, and the like; and ampholytic surfactants, such as laurylamidopropyl acetate betaine, dodecyl sulfobetaine, and the like. The surfactants can be used alone or in any combination thereof. In some embodiments of the present invention, the concentration of the surfactant is from 0.1 wt. % to 1.75 wt. %, or 0.25 wt. % to 1.5 wt. %, based on the total amount of medium temperature sealing solution.

In some embodiments of the present invention, the surfactant is preferably selected from the group consisting of anionic surfactants, nonionic surfactants, and any combination thereof. In further embodiments, the surfactant is more preferably selected from the group consisting of dodecyl benzene sulfonic acid, sodium dodecyl benzene sulfonate, methyl dodecylbenzene sulfonate, sodium alkyl ether sulfonates, dodecyl diphenyl ether sulfonate disodium salt, alkyl naphthalene sulfonates, polynaphthalene sulfonates, sodium alkyl ether sulfates, sodium lauryl sulphate, alkyl ethoxy sulfate, sodium dodecyl sulfate, sodium laureth sulfate, ammonium laureth sulfate, ammonium lauryl sulfate, alcohol alkoxylate with an alkyl chain of 8-12 carbon atoms, 6-9 ethylene oxide units (EO), or alkyl chain of 10-12 carbon atoms, 5-10 ethylene oxide units (EO), and 5-10 propylene oxide units (PO), and any combination thereof.

Examples of commercially available sources of the surfactants are, for example, nonionic, alcohol ethoxylate, C8-12, 6-9 EO (Fluidol W 100 MO) from BASF China, and nonionic, alcohol ethoxylate, C12-15, 12-14 EO (Neodol 25-12) from Shell China. Dodecyl diphenyl ether sulfonate disodium salt, (PARETH-8) from Nantong Chenrun Chemical Co., Ltd. Sodium dodecyl benzene sulfonate (98 wt. %) from Shanghai Aladdin Bio-chemical Technology Co., Ltd.

### Water

The medium temperature sealing solution of the present invention comprises water as solvent to dissolve all components to form the sealing solution. In some embodiments of the present invention, it is preferably to use deionized water as solvent.

### pH Value of the Medium Temperature Sealing Solution

The operating pH value of the medium temperature sealing solution is 4.5 to 7.0, or 5.0 to 7.0, or 5.0 to 6.0. The pH value range of the medium temperature sealing solution could help to get a good appearance of aluminum alloy and get good corrosion resistant performance. The upper limit of pH value is 7.0, or 6.8, or 6.5, or 6.0; the lower limit of pH value is 4.5, or 4.7, or 4.8, or 5.0. One or more pH-adjusting agents, including minor amounts of mineral acids, basic compositions, and organic acids may be used to adjust the pH value of the medium temperature sealing solution to above desired value.

### Optional Additives

The medium temperature sealing solution of the present invention may further comprise optional additives. The selection of suitable additives for the medium temperature sealing solution depends on the specific intended use of the medium temperature sealing solution and can be determined in the individual case by those skilled in the art.

### <First pH Adjuster>

The medium temperature sealing solution of the present invention may optionally comprise at least one first pH adjuster. The first pH adjuster of the present invention may be any commonly used pH adjuster and includes but not limited to boric acid, acetic acid, guanidinoacetic acid, guanidine nitrate, sulfuric acid, nitric acid, aqueous ammonia, tetramethyl ammonium hydroxide, sodium carbonate, sodium hydroxide, potassium carbonate, potassium hydroxide, diethylenetriamine, diethanol amine, triethanol amine, and the like. The first pH adjusters can be used alone or in any combination.

### <Second pH Adjuster>

The high temperature sealing solution of the present invention may optionally comprise at least one second pH adjuster. The second pH adjuster of the present invention may be any commonly used pH adjuster and includes but not limited to boric acid, acetic acid, guanidinoacetic acid, guanidine nitrate, sulfuric acid, nitric acid, aqueous ammonia, tetramethyl ammonium hydroxide, sodium carbonate, sodium hydroxide, potassium carbonate, potassium hydroxide, diethylenetriamine, diethanol amine, triethanol amine, and the like. The second pH adjusters can be used alone or in any combination. The second pH adjustor may or may not be the same as the first pH adjustor used in the medium temperature sealing solution.

### Preparing Method of the Medium Temperature Sealing Solution

The medium temperature sealing solution might be prepared by dissolving the source of the first ions, the source of the fluoride ions, the source of the second ions, the surfactant, and optional additive(s) (if present), in water.

In some embodiments of the present invention, the medium temperature sealing solution is preferably prepared by steps of:
a) dissolving the source of the first ions, the source of the fluoride ions, the source of the second ions, and the surfactant in water with stirring so as to obtain a solution; and
b) adding the pH adjustor to the solution obtained in step a) to achieve an appropriate pH for the solution.

In some embodiments of the invention, the medium temperature sealing solution preferably has a pH from 4.5 to 7, and more preferably from 5 to 6.

### Preparing Method of the High Temperature Sealing Solution

The high temperature sealing solution may be prepared by dissolving at least one water-soluble polymer which is selected from polyacrylic acid, poly(acrylic acid) sodium salt, acrylic acid-2-acrylamino-2-methylpropane sulfonic acid copolymer, poly(sulfonic acid), polyacrylamidomethylpropane sulfonic acid, polyethyleneimine, polyethers, and polyamides; polyacrylamide, having a weight-average molecular weight (Mw) from 5,000 to 400,000.

As used herein, “Mw” refers to the weight average molecular weight and means the theoretical value as determined by Gel Permeation Chromatography (GPC) relative to linear polystyrene standards of 1.1 M to 580 Da and may be performed using Waters 2695 separation module with a Waters 2414 differential refractometer (RI detector).

In some embodiments of the present invention, the high temperature sealing solution is preferably prepared by steps of:
a) dissolving at least one water-soluble polymer which is selected from water-soluble polyacrylic acid, poly(acrylic acid) sodium salt, acrylic acid-2-acrylamino-2-methylpropane sulfonic acid copolymer, poly(sulfonic acid), polyacrylamidomethylpropane sulfonic acid, Polyethylenimine, polyethers, and polyamides; polyacrylamide, having a weight-average molecular weight from 5,000 to 400,000, in water with stirring so as to obtain a solution; and
b) adjusting to the solution obtained in step a) to achieve a proper pH for the solution if needed.

In some embodiments of the present invention, the high temperature sealing solution preferably has a pH from 7 to 12, preferably from greater than 7 to 12, or preferably from 7.1 to 12, and more preferably from 8 to 11.5.

In some embodiments of the present invention, the high temperature sealing solution is a clear and uniform solution without delamination.

### Method for Sealing an Anodized Aluminum Alloy Surface

A method for sealing an anodized aluminum alloy surface by using the sealing solution kit according to any one of embodiments, comprising steps of:
a) contacting said surface with the medium temperature sealing solution at a temperature from 50 to 95° C. and a pH value of 4.5 to 7;
b) contacting said surface with the high temperature sealing solution at a temperature from greater than 80° C. to no less than 100° C. and a pH value of 7 to 12;
c) drying the liquid layer formed in operation (a) and (b) to form a treated surface.

In some embodiments of present invention, immediately after step a), an effective rinse with deionized water is applied to remove the residue of first-step chemical. In further embodiments of present invention, after step b), aluminum parts go through enough deionized water rinse to get a clean surface. Sealing treatment time of the anodized aluminum surface with the 2 aqueous sealing baths are similar, both depend on the thickness of the anodized aluminum oxide layer on the part surface. In general, the sealing treatment time is preferably about 1-3 minutes per um. This range of the sealing time ensures the sufficient sealing performance, meanwhile keep good appearance without dust issue, as the alumina hydrates over deposition is inhibited.

In some embodiments of the present invention, the medium temperature sealing solution is preferably used for sealing at a temperature from higher than 50° C. to no higher than 95° C., or 65° C. to no higher than 85° C., or more preferably from 70° C. to 85° C.

In some embodiments of the present invention, the high temperature sealing solution is preferably used for sealing at a temperature from higher than 80° C. to no higher than 100° C., and more preferably from 85° C. to 100° C.

By way of non-limiting example, the most commonly anodized substrate is aluminum alloys, although processes also exist for titanium, zinc, magnesium, niobium, zirconium, hafnium and tantalum. The typical alloying elements for aluminum are copper, magnesium, manganese, silicon, tin and zinc. Common anodizing for automotive components is based on 5000 series aluminum alloyed with magnesium, for example 5657 and 5505, and 6000 series aluminum alloyed with magnesium and silicon (Aluminum alloy—Wikipedia), for example 6063 and 6401.

The medium temperature sealing solution of the present invention can be used alone as a one-step sealing solution. Preferably, the medium temperature sealing solution is used together with the high temperature sealing solution of the present invention. The medium temperature sealing solution could also be used together with a high temperature sealing solution commonly used in the art.

In some embodiments, the medium temperature sealing solution of the present invention can be used alone in a one-step sealing method, and the anodized aluminum alloy may be sealed by contacting a surface of the anodized aluminum alloy with the medium temperature sealing solution of the present invention at a temperature from 50 to 95° C. and at a pH from 4.5 to 7. Preferably, the anodized aluminum alloy may be sealed by contacting a surface of the anodized aluminum alloy with the medium temperature sealing solution of the present invention at a temperature from 70 to 85° C. and at pH from 5 to 6 for 1-3 minutes per um of anodizing layer thickness.

The time slot between the medium temperature sealing and the high temperature sealing should be no more than 24 hours, in increasing order of preference, 24, 12, 6.0, 5.0, 4.0, 3.0, 2.0, 1.0, 0.50, 0.33, 0.25, or 0.1 hours. The preferred time slot between the medium temperature sealing and the high temperature sealing should be no more than 20 minutes.

The surface of the anodized aluminum alloy sealed according to the medium temperature sealing step has good corrosion resistance and dye spot.

In some embodiments, the medium temperature sealing solution of the present invention is used together with the high temperature sealing solution as previous described which comprises at least one water-soluble polymer selected from poly(meth)acrylic acid and its derivatives, polyether and its derivatives, polyamide and its derivatives, poly(sulfonic acid) and its derivatives and mixtures thereof, and water. The anodized aluminum alloy may be sealed by a two-step sealing method using the two-step sealing solution kit comprising steps of:
a) contacting a surface of the anodized aluminum alloy with the medium temperature sealing solution of the present invention at a temperature from 50 to 95° C. and at a pH from 4.5 to 7; and
b) contacting the surface of the anodized aluminum alloy with the high temperature sealing solution of the present invention at a temperature from higher than 80° C. to less than 100° C. and at a pH from 7 to 12.

Preferably, the surface of the anodized aluminum alloy is rinsed with a sufficient amount of water after the medium temperature sealing step and/or the high temperature sealing step to remove the sealing solution residuals. After this step, drying the liquid layer formed in above operations to form a treated surface.

A sealing solution according to the invention may be applied to an anodized aluminum alloy surface of a workpiece and dried thereon by any convenient method, several of which is readily apparent to those skilled in the art.

The surface of the anodized aluminum alloy sealed according to the two-step sealing method has even better corrosion resistance and dye spot, which has no appearance change when subjected to pH 1 and pH 13.5 test (TL 182 2012, without heat aging 1 hr. at 40° C.) at 20-23° C. each for 10 minutes separately.

### Non-Limiting Listing of Particular Embodiments

Embodiment 1. A sealing solution kit comprises:
a) a medium temperature sealing solution; and
b) a high temperature sealing solution;
wherein the medium temperature sealing solution, based on the total volume of the medium temperature sealing solution, comprising: water; 0.6 to 2.6 g/L of fluoride ions; 2.0 to 5.0 g/L of a first ion selected from a group consisting of nickel ions, cobalt ions, chromium ions, cadmium ions and mixtures thereof; 0.03 to 1.3 g/L of a second ion selected from the group consisting of zirconium ions, titanium ions, silicon-containing ions, and mixtures thereof; an effective amount of surfactant;
the high temperature sealing solution comprising, based on the total volume of the high temperature sealing solution, water and 0.1 g/L to 100 g/L of water-soluble polymer, the water-soluble polymer having a weight-average molecular weight of 5,000 g/mol to 400,000 g/mol, and the water-soluble polymer being selected from the group consisting of poly(meth)acrylic acid and its derivatives, polyether and its derivatives, polyamide and its derivatives, poly(sulfonic acid) and its derivatives and mixtures thereof.

Embodiment 2. The sealing solution kit according to embodiment 1, wherein the poly(meth)acrylic acid derivatives comprise poly((methyl)acrylic acid), poly(acrylic acid) sodium salt, poly(methacrylic acid) ammonium salt, poly(vinyl acetate), acrylic acid-2-acrylamino-2-methylpropane sulfonic acid copolymer and other acrylic polymer.

Embodiment 3. The sealing solution kit according to any one of preceding embodiments, wherein the poly(meth)acrylic acid and its derivatives have a weight-average molecular weight of 5,000 g/mol to 100,000 g/mol.

Embodiment 4. The sealing solution kit according to any one of preceding embodiments, wherein the polyether derivatives comprise poly(ethylene oxide), polyethylene glycol.

Embodiment 5. The sealing solution kit according to any one of preceding embodiments wherein the polyether and its derivatives have a weight-average molecular weight of 80,000 g/mol to 400,000 g/mol.

Embodiment 6. The sealing solution kit according to any one of preceding embodiments, wherein the polyamide derivatives comprise polyacrylamide, poly(N-vinyl acetamide) and other amide polymers.

Embodiment 7. The sealing solution kit according to any one of preceding embodiments, wherein the polyamide and its derivatives have a weight-average molecular weight of 8,000 g/mol to 100,000 g/mol.

Embodiment 8. The sealing solution kit according to any one of preceding embodiments, wherein the poly(sulfonic acid) derivatives comprise poly((vinyl)sulfonic acid) sodium salt, polyacrylamidomethylpropane sulfonic acid, poly(styrenesulfonic acid), poly(styrenesulfonic acid) sodium salt and other sulfonic polymer.

Embodiment 9. The sealing solution kit according to any one of preceding embodiments, wherein the poly(sulfonic acid) and its derivatives have a weight-average molecular weight of 100,000 g/mol to 300,000 g/mol.

Embodiment 10. The sealing solution kit according to any one of preceding embodiments, wherein the pH value of the high temperature sealing solution is from 7 to 12.

Embodiment 11. The sealing solution kit according to any one of preceding embodiments, wherein the pH value of the high temperature sealing solution is from greater than 7 to 12.

Embodiment 12. The sealing solution kit according to any one of preceding embodiments, wherein the pH value of the high temperature sealing solution is 7.1 to 12.

Embodiment 13. The sealing solution kit according to any one of preceding embodiments, wherein the pH value of the high temperature sealing solution is 8 to 11.5.

Embodiment 14. The sealing solution kit according to any one of preceding embodiments, wherein the concentration of the water-soluble polymer is 0.1 g/L to 20 g/L.

Embodiment 15. The sealing solution kit according to any one of preceding embodiments, wherein the surfactant comprises anionic surfactants, non-ionic surfactants, ampholytic surfactants and mixtures thereof with a concentration of 0.1%-1.75% based on the total amount of the medium temperature sealing solution.

Embodiment 16. The sealing solution kit according to any one of preceding embodiments, wherein the surfactant comprises anionic surfactants, non-ionic surfactants, ampholytic surfactants and mixtures thereof with a concentration of 0.25%-1.5% based on the total amount of the medium temperature sealing solution.

Embodiment 17. The sealing solution kit according to any one of preceding embodiments, wherein the first ion is divalent nickel ion with a concentration of 2.1 to 5.0 g/L.

Embodiment 18. The sealing solution kit according to any one of preceding embodiments, wherein the second ion is zirconium ion with a concentration of 0.05 to 1.2 g/L.

Embodiment 19. The sealing solution kit according to any one of preceding embodiments, wherein the concentration of the fluoride ion in the medium temperature sealing solution is from 0.7 to 2.4 g/L.

Embodiment 20. The sealing solution kit according to any one of preceding embodiments, wherein the pH value of the medium temperature sealing solution is from 4.5 to 7.

Embodiment 21. A method for sealing an anodized aluminum alloy surface by using the sealing solution kit according to anyone of preceding embodiments, comprising steps of:
a) contacting said surface with the medium temperature sealing solution at a temperature from 50 to 95° C. and a pH value of 4.5 to 7; and
b) contacting said surface with the high temperature sealing solution at a temperature from greater than 80° C. to no less than 100° C. and a pH value of 7 to 12.
c) drying the liquid layer formed in operation (a) and (b) to form a treated surface.

Embodiment 22. An article having at least one portion that comprises the treated surface of any one of preceding embodiments.

Embodiment 23. The article of embodiment 22, said treated surface has corrosion resistance properties characterized by no appearance change when subjected to pH 1 and pH 13.5 test (TL 182 2012, without Heat aging 1 hr. at 40° C.) at 20-23° C. each for 10 minutes separately. Heat aging 1 hr. at 40° C. will not affect final test result in current disclosure, so we omitted heat aging for below anti-acid and alkali test.

Embodiment 24. A vehicle comprising the article of any one of embodiments 22 to 23 as automotive part.

### EXAMPLES

The present invention will be further described and illustrated in detail with reference to the following examples. The examples are intended to assist one skilled in the art to better understand and practice the present invention, however, are not intended to restrict the scope of the present invention. All numbers in the examples are based on weight unless otherwise stated.

It should be understood that alternatively, the components listed need not necessarily all be provided by separate chemicals. For example, HF may provide pH adjustment as well as free fluoride ions.

### Example 1

### <Preparation of Anodized Aluminum Alloy>

Aluminum Alloy (6000 series alloyed with magnesium and silicon, 6061) was anodized by steps of:
a) cleaning the surface of aluminum alloy with degreasing and polishing to remove the surface grease, dirt, and oxide layer to get a clean and fresh surface;
b) immersing the aluminum alloy in sulfuric acid with a concentration of 200 g/L at a temperature of 20° C.;
c) anodizing the aluminum alloy under a voltage of 12-15 V for 20 minutes to achieve an aluminum oxide layer having a thickness of from 5 to 15 μm and
d) rinsing the anodized aluminum alloy with de-ionized water.

### <Preparation of Medium Temperature Sealing Solution>

Medium temperature sealing solution was prepared by steps of:
a) All raw materials are directly used without any special treatment. Dissolving 0.336 g of potassium fluoride (powder, commercially available from Shanghai Aladdin Bio-chemical Technology Co., Ltd.), 2.82 g of Zr(NO₃)₄·5H₂O (powder, commercially available from Sinopharm Chemical Reagent Co., Ltd.), 5 g of NiF₂·4H₂O (powder, commercially available from Sinopharm Chemical Reagent Co., Ltd.), 13 g of Ni(CH₃COO)₂·4H₂O (powder, commercially available from Sinopharm Chemical Reagent Co., Ltd.), 1.5 g of sodium dodecyl benzene sulfonate (liquid, commercially available from Shanghai Aladdin Bio-chemical Technology Co., Ltd., the manufacturer showed 98 wt. %), in 1 L of de-ionized water; and
b) adjusting the pH of the solution from step a) to 5.5 pH value with NaOH.

### <Preparation of High Temperature Sealing Solution>

High temperature sealing solution was prepared by steps of:
a) dissolving 15 g polyether (Dow POLYOX WSR N-10 with Mw of 100000 g/mol) in 1 L of de-ionized water; and
b) adjusting the pH of the solution from step a) to 11 pH value with of NaOH.

### <Sealing of Anodized Aluminum Alloy>

The anodized aluminum alloy was sealed by steps of
a) immersing the anodized aluminum alloy in the medium temperature sealing solution at temperature of 75° C., sealing time is 1-3 minutes per um of anodizing layer;
b) rinsing the surface of the anodized aluminum alloy with de-ionized water;
c) immersing the anodized aluminum alloy from step b) in the high temperature sealing solution at temperature of 95° C., sealing time is 1-3 minutes per um of anodizing layer; and
d) rinsing the surface of the anodized aluminum alloy with de-ionized water;
e) drying the liquid layer formed in preceding operations to form a treated surface.

The sealed anodized aluminum alloy sample was subjected to various of tests.

### Example 2-36, and CE1-CE22

The sealing solutions of E2 to E36 and CE1 to CE22 were prepared in reference to Example 1. The anodized aluminum alloy of E2 to E36 and CE1 to CE22 were sealed in reference to Example 1. More details are listed in below result part.

### Test Methods

### <Dye Spot Test>

The degree of sealing or compacting of the aluminum oxide layer can be determined using the dye spot test in accordance with DIN EN 12373-4. Here, the dyeability or dye absorption capacity of the anodized surface after the sealing by the method according to the invention is determined photometrically by means of UV-vis reflection spectroscopy and compared with the dyeability of the freshly anodized surface. In the dye spot test, the anodized aluminum surface is dyed after a defined pretreatment using dye in accordance with DIN EN 12373-4. The test area is wetted with an acid solution (25 ml/L sulfuric acid, 10 g/L KF), the acid solution on the test area is washed off after precisely one minute and the test area is then dried. The test area is then wetted with dye solution (5 g/L Sanodal Blue), which is left to act for one minute. After rinsing under running water, the colored test area is freed of loosely adhering dye by rubbing using a mild powder cleaner. After drying the surface, surface is checked by visual. The dyeing of the surface correlates directly with the degree of sealing of the aluminum oxide layer. A sealed oxide layer possesses the lowest dye absorption capacity, while the open-pored, unsealed oxide layer can absorb the dye well. The ability of the aluminum oxide to absorb dye is directly dependent on the free surface of the porous aluminum oxide layer.

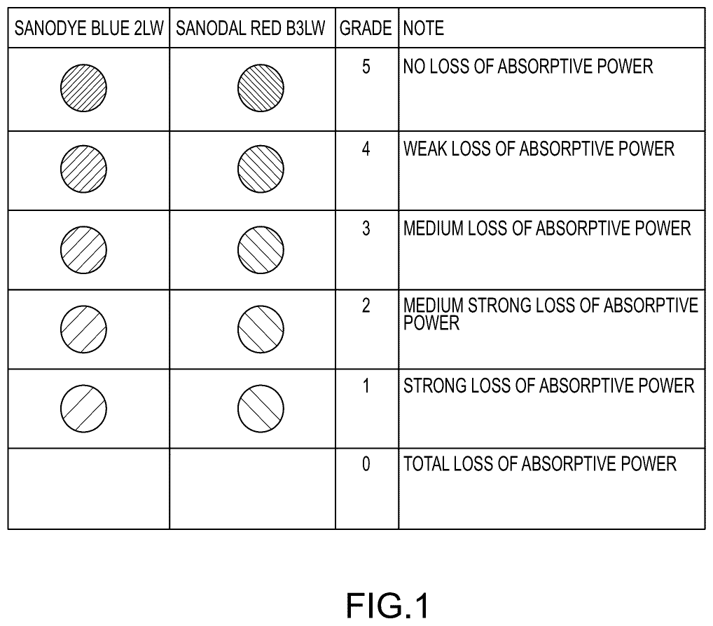

FIG. 1 shows the numerical grade classification of dye spot testing results. Grade 0 (total loss of absorptive power) and Grade 1 (strong loss of absorptive power) are treated as no surface changes. Grade 0 is a preferred result. The sealed anodized aluminum alloy sample is ranked as “Pass” for the dye spot test when grade 0 or grade 1 is achieved. Otherwise, the sample is ranked as “Fail”.

### <Appearance>

The appearance of the sealed anodized aluminum alloy sample was evaluated by visual inspection. If there is no appearance change including no gloss lost and the surface is not foggy or dusty, the sealed anodized aluminum alloy sample was ranked as “Pass” for the appearance. Otherwise, the sample was ranked as “Fail”.

### <Corrosion Resistance>

The corrosion resistance of the sealed anodized aluminum alloy sample was tested by anti-acid & alkali test.

Anti-acid & alkali test was performed refer to TL 182 2017 acid/heat/alkali resistance. Heat aging 1 hr. at 40° C. will not affect final test result in current disclosure, so we omitted heat aging for below anti-acid and alkali test. The acid and alkali resistance test must be performed in a temperature range of 23-25° C.

Detailed steps include:
a) immersing the sealed anodized aluminum alloy sample in a HCl solution with pH of 1 for 10 mins.
b) rinsing the sealed anodized aluminum alloy sample with de-ionized water and leaving the sample in air to dry;
c) immersing the sealed anodized aluminum alloy sample in a solution with pH of 13.0 or 13.5 for 10 mins (pH 13.5 Test solution: 12.7 g Sodium Hydroxide (NaOH), 4.64 g Sodium Phosphate Dodecahydrate (Na₃PO₄·12H₂O), 0.33 g Sodium Chloride (NaCl), in 1 L deionized water. pH 13.0 Test solution: 4 g Sodium Hydroxide (NaOH), 4.64 g Sodium Phosphate Dodecahydrate (Na₃PO₄·12H₂O), 0.33 g Sodium Chloride (NaCl) in 1 L deionized water. Solution preparation described in Standard GMW14665. 3.8 Specification for Alkaline Resistance); and
d) rinsing the sealed anodized aluminum alloy sample with de-ionized water and leaving the sample in air to dry.

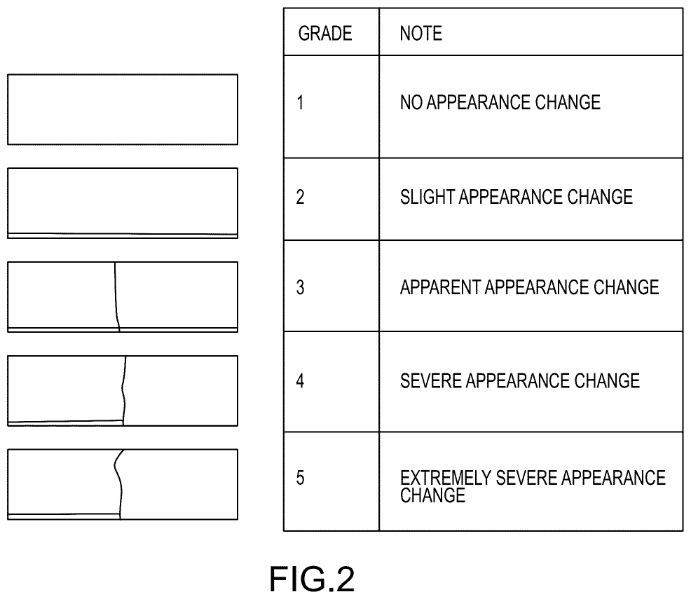

FIG. 2 displays detailed numerical grade ranking and corresponding appearance for assessing performance in the above-described corrosion testing of sealed anodized aluminum alloy samples. If there is no appearance change, results are marked as “Grade 1”, if there is a slight appearance change, mark as “Grade 2”. For the sealed anodized aluminum alloy samples that show a result equal to or worse than grade 2 (grade 3 to grade 5), results are ranked as “Fail” for anti-acid & alkali test. For the sealed anodized aluminum alloy samples showing a result equal to grade 1 or better than grade 2, results are rank as “Pass” for anti-acid & alkali test. Grade 1 is a preferred result.

### Results

Table 1 shows dye spot and corrosion resistance properties (pH 1+13.5) of the anodized aluminum alloys Examples 1 to 5 (E1-E5) and Comparative Examples 1-3 (CE1-CE3) sealed by the medium temperature sealing solutions with different concentrations of the first ions and fluoride ions.

Test panels prepared according to the foregoing procedures were immersed in six different sealing solutions as the first step, compositions including 0.336 g/L KF, 2.82 g/L Zr(NO₃)₄·5H₂O, 1.5 g/L sodium dodecyl benzene sulfonate, and different amount of NiF₂·4H₂O and Nickel acetate·4H₂O to adjust Ni and F content in bath. All step 1 sealing solutions were maintained at 80° C., sealing time is 20 minutes. Then go to the same second step containing 15 g/L of polyether (Dow POLYOX WSR N-10) operated at 95° C. for 20 minutes.

The dye spot and pH 1+13.5 are tested. The results are given below in Table 1.

TABLE 1

| | Step 1 | | | | | | | |
|---|---|---|---|---|---|---|---|---|
| CE | Additive Amounts in Sealing Solution Examples | | | | | | Dye | |
| or | | Nickel | Ni | | | | Spot | Corrosion |
| Ex. | NiF₂•4H₂O | acetate•4H₂O | ions | F ions | Zr ions | | Test | resistance |
| No. | (g/L) | (g/L) | (g/L) | (g/L) | (g/L) | Step 2 | Result | pH 1 + 13.5 |
| CE1 | 2.5 | 3.3 | 1.6 | 0.7 | 0.6 | High | Fail, | Pass, |
| | | | | | | Temp. | Grade 3 | Grade 1 |
| CE2 | 1.8 | 7.5 | 2.4 | 0.5 | 0.6 | Sealing | Fail, | Fail, |
| | | | | | | | Grade 2 | Grade 2 |
| CE3 | 12 | 0 | 4.2 | 2.8 | 0.6 | | Fail, | Fail, |
| | | | | | | | Grade 2 | Grade 2 |
| E1 | 2.5 | 6.5 | 2.4 | 0.7 | 0.6 | | Pass, | Pass, |
| | | | | | | | Grade 0 | Grade 1 |
| E2 | 5 | 13 | 4.9 | 1.2 | 0.6 | | Pass, | Pass, |
| | | | | | | | Grade 0 | Grade 1 |
| E3 | 7.5 | 6.5 | 4.2 | 1.8 | 0.6 | | Pass, | Pass, |
| | | | | | | | Grade 0 | Grade 1 |
| E4 | 6 | 6 | 2.1 | 0.8 | 0.6 | | Pass, | Pass, |
| | | | | | | | Grade 0 | Grade 1 |
| E5 | 10 | 6.494 | 5.0 | 2.4 | 0.6 | | Pass, | Pass, |
| | | | | | | | Grade 0 | Grade 1 |

Table 2 shows properties of the anodized aluminum alloys CE4-CE6 and E6-E10 sealed by the medium temperature sealing solutions with different concentrations of the second ions.

Test panels prepared according to the foregoing procedures were immersed in six different sealing solutions as the first step, including 0.336 g/L KF, 5 g/LNiF₂·4H₂O and 13 g/L Nickel acetate 4H₂O, 1.5 g/L sodium dodecyl benzene sulfonate, and different amount of Zr(NO₃)₄·5H₂O or H₂ZrF₆ to adjust Zr content in bath. All sealing solutions were maintained at 80° C., sealing time is 20 minutes. Then go to the same second step containing 15 g/L of polyether (Dow POLYOX WSRN-10) operated at 95° C. for 20 minutes.

TABLE 2

| | Step 1 | | | | | | |
|---|---|---|---|---|---|---|---|
| CE or | | | Zr | F | Ni | | Corrosion |
| Ex. | Zr(NO₃)₄•5H₂O | H₂ZrF₆ | ions | ions | ions | | resistance |
| No. | (g/L) | (g/L) | (g/L) | (g/L) | (g/L) | Step 2 | pH 1 + 13.5 |
| CE4 | 0 | 0 | 0 | 1.2 | 4.9 | 15 g/L of | Fail, Grade 3 |
| CE5 | 7.04 | 0 | 1.5 | 1.2 | 4.9 | polyether (Dow | Fail, Grade 3 |
| CE6 | 0 | 0 | 0 | 0.8 | 1.2 | POLYOX WSR | Fail, Grade 4 |
| E6 | 0.47 | 0 | 0.1 | 1.2 | 4.9 | N-10), operated | Pass, Grade 1 |
| E7 | 2.82 | 0 | 0.6 | 1.2 | 4.9 | at 95° C. for 1-3 | Pass, Grade 1 |
| E8 | 0 | 1.36 | 0.6 | 1.2 | 4.9 | minutes per um | Pass, Grade 1 |
| E9 | 5.63 | 0 | 1.2 | 1.2 | 4.9 | | Pass, Grade 1 |
| E10 | 0.24 | 0 | 0.05 | 1.2 | 4.9 | | Pass, Grade 1 |

Table 3 shows properties of the anodized aluminum alloys sealed by the sealing solution kits with different water-soluble polymers.

The effect of polymer upon seal quality of finished parts was evaluated. The anodized aluminum panels prepared according to the foregoing procedures were sealed by firstly immersion in the same 1st step medium temperature sealing solution according to the instant invention including 0.336 g/L KF, 2.82 g/L Zr(NO₃)₄·5H₂O, 5 g/L NiF₂·4H₂O and 13 g/L Nickel acetate·4H₂O (Ni 4.9 g/L, F 1.2 g/L, Zr 0.6/L), and 1.5 g/L sodium dodecyl benzene sulfonate, and maintained at 80° C., sealing time is 20 minutes. Then immersion in different 2nd step sealing solution prepared by different types of polymers; all second steps are alkaline, pH value is adjusted to 8-11.5 by either acetic acid and sodium hydroxide or potassium hydroxide, sealing temperature is 95° C. for 20 minutes.

The pH 1+13.5 are tested. The results of E11-E16 and CE7-CE14 are given below:

TABLE 3

| CE or | | Corrosion resistance |
|---|---|---|
| Ex. No. | Step 2 | pH 1 + 13.5 |
| CE7 | 15 g/L, water soluble polyacrylic acid, Mw = 4,500 | Fail, Grade 2 |
| E11 | 15 g/L, water soluble polyacrylic acid, Mw = 5,000-10,000 | Pass, Grade 1 |
| E12 | 15 g/L, water soluble polyacrylic acid, Mw = 10,000-20,000 | Pass, Grade 1 |
| E13 | 15 g/L, water soluble polyacrylic acid, Mw = 50,000-80,000 | Pass, Grade 1 |
| E14 | 15 g/L, water soluble polyether, Mw = 100,000. | Pass, Grade 1 |
| E15 | 15 g/L, water soluble polyether, Mw = 300,000. | Pass, Grade 1 |
| CE8 | 15 g/L, water soluble polyether, Mw = 900,000. | Fail, Grade 3 |
| E16 | 15 g/L, water soluble polyamide, Mw = 50,000-70,000 | Pass, Grade 1 |
| CE9 | 15 g/L, water soluble polyethylene glycol, Mw = 40,000. | Fail, Grade 3 |
| CE10 | 15 g/L, water soluble polyvinyl pyrrolidone, Mw = 8,000-700,000 | Fail, Grade 3 |
| CE11 | 15 g/L, aqueous polyurethane dispersion, Mw = ~200,000. | Fail, Grade 4 |
| CE12 | 15 g/L, acrylic copolymer emulsion, Mw = ~200,000. | Fail, Grade 3 |
| CE13 | 15 g/L, ethylene acrylic acid copolymers dispersion, | Fail, Grade 4 |
| | Mw = ~17,000. | |
| CE14 | 15 g/L, urethane dispersion, Mw = ~100,000. | Fail, Grade 3 |

Some specific types of water-soluble polymers including polyacrylic acid, polyether and polyamide types are benefit for good pH 1+13.5 performance compared to other water-soluble polymers. Furthermore, molecular weight also significantly affects seal quality. Regarding pH 1+13.5 results, suitable molecular weight range is 5,000 to 400,000 including from 5,000 to 100,000 for polyacrylic acid, or 80,000 to 400,000 for polyether, or 10,000-100,000 for polyamide. Appropriate polymer and appropriate molecular size can ensure sufficient sealing, then improve anti-corrosion performance.

Table 4 shows properties of the anodized aluminum alloys sealed by the sealing solution kits with different concentrations of water-soluble polymer.

The effect of polymer concentration upon seal quality of finished parts was evaluated. The anodized aluminum panels prepared according to the foregoing procedures were sealed by firstly immersion in the same first step medium temperature sealing solution according to the instant invention including 0.336 g/L KF, 2.82 g/L Zr(NO₃)₄·5H₂O, 5 g/L NiF₂·4H₂O and 13 g/L Nickel acetate·4H₂O (Ni ions is 4.9 g/L, F ions is 1.2 g/L, Zr ions is 0.6/L), and 1.5 g/L sodium dodecyl benzene sulfonate, and maintained at 80° C., sealing time is 20 minutes. Then immersion in the second step high temperature sealing solution prepared by different concentration of water-soluble polymers; all second steps are alkaline, pH value is adjusted to 8-11.5 by either acetic acid and sodium hydroxide or potassium hydroxide, sealing temperature is 95° C. for 20 minutes.

The pH 1+13.5 are tested. The results of E17-E24 and CE15-CE16 are given below. It can be seen that water-soluble polymer concentration should be higher than 0.1 g/L. If further higher than 100 g/L, appearance issue appears with rill mark, so polymer concentration is optimized between 0.1 g/L to 100 g/L, or 0.1 g/L to 20 g/L, or 0.2 g/L to 20 g/L.

TABLE 4

| CE or | | Conc. of water- | Corrosion resistance |
|---|---|---|---|
| Ex. No. | Step 2 | soluble polymer | pH 1 + 13.5 |
| CE15 | water soluble polyacrylic acid (Shanghai | 0.05 g/L | Fail, Grade 2 |
| E17 | Zhaode Chemicals, polyacrylic acid), | 0.2 g/L | Pass, Grade 1 |
| E18 | Mw = 5,000-10,000 | 0.5 g/L | Pass, Grade 1 |
| E19 | | 5 g/L | Pass, Grade 1 |
| E20 | | 20 g/L | Pass, Grade 1 |
| E21 | water soluble polyether, Mw = 100,000. | 2 g/L | Pass, Grade 1 |
| E22 | | 15 g/L | Pass, Grade 1 |
| E23 | water soluble polyamide (Dupont PA 610), | 2 g/L | Pass, Grade 1 |
| E24 | Mw = 10,000-70,000 | 15 g/L | Pass, Grade 1 |
| CE16 | w/o polymer, only deionized water | 0 g/L | Fail, Grade 3 |

Table 5 shows the effect of pH value of second high temperature sealing step upon seal quality of uncolored parts was evaluated. Test panels prepared according to the foregoing procedures were firstly immersed in typical 1st step sealing solution in the instant invention including 0.336 g/L KF, 2.82 g/L Zr(NO₃)₄·5H₂O, 5 g/L NiF₂·4H₂O and 13 g/L Nickel acetate·4H₂O (concentration of Ni ions is 4.9 g/L, concentration of F ions is 1.2 g/L, concentration of Zr ions is 0.6/L), and 1.5 g/L sodium dodecyl benzene sulfonate, and maintained at 80° C., sealing time is 20 minutes. Then immersion in seven different pH of second step sealing solution, all of them are prepared by 15 g/L of polyacrylic acid but adjusted to different pH value by either acetic acid and sodium hydroxide or potassium hydroxide. The second step was operated at 95° C. for 20 minutes.

The appearance, dye spot, pH 1+13.5 of uncolored parts of E25-E29 and CE17-CE18 are tested. A qualified seal quality and corrosion resistance quality is achieved at pH value from 7 to 12, a better seal quality and corrosion resistance quality is achieved at a pH value of 8-12. It can be observed the whole process has both better acid & alkali corrosion resistance (pH 1+13.5) and seal quality when the second step is alkaline environment. For CE 19, it shows extremely slight corrosion mark, the result of alkali corrosion resistance is much better than grade 2 and close to grade 1. It is defined as “Pass”.

TABLE 5

| | pH of step | | | |
|---|---|---|---|---|
| CE | 2 high | | | Corrosion |
| or Ex. | temperature | | Dye Spot | resistance |
| No. | sealing | Appearance | Test Result | pH 1 + 13.5 |
| CE17 | 2.86 | Pass | Fail, Grade 3 | Fail, Grade 4 |
| CE18 | 5.77 | Pass | Pass, Grade 1 | Fail, Grade 3 |
| E25 | 7.0 | Pass | Pass, Grade 0 | Pass, close to |
| | | | | grade 1, better |
| | | | | than grade 2. |
| E26 | 8.2 | Pass | Pass, Grade 0 | Pass, Grade 1 |
| E27 | 9.5 | Pass | Pass, Grade 0 | Pass, Grade 1 |
| E28 | 10.5 | Pass | Pass, Grade 0 | Pass, Grade 1 |
| E29 | 11.5 | Pass | Pass, Grade 0 | Pass, Grade 1 |

Table 6 shows the effect of surfactants of the first step on finished parts performance. Test panels prepared as indicated above were immersed in 2 step sealing baths, first steps totally refer to the instant invention containing 0.336 g/L KF, 2.82 g/L Zr(NO₃)₄·5H₂O, 5 g/L NiF₂·4H₂O and 13 g/L Nickel acetate·4H₂O, and different surfactants, then go to same second step of this invention. All first step sealing solutions were maintained at 80° C., sealing time is 20 minutes. Second step contained 15 g/L of polyether (Dow POLYOX WSR N-10) operated at 95° C. for 20 minutes.

The dye spot and pH 1+13.5 of uncolored parts were evaluated.

TABLE 6

| CE or Ex. | Surfactant in the medium | Dye Spot | Corrosion resistance |
|---|---|---|---|
| No. | temperature sealing solution | Test Result | pH 1 + 13.5 |
| CE19 | 0 | Pass, Grade 0 | Fail, Grade 3 |
| E30 | 1.5 wt. ‰ anionic (dodecyl diphenyl | Pass, Grade 0 | Pass, Grade 1 |
| | ether sulfonate disodium salt) | | |
| E31 | 1 wt. ‰ anionic (sodium dodecyl | Pass, Grade 0 | Pass, Grade 1 |
| | benzene sulfonate) | | |
| E32 | 0.5 wt. ‰ anionic (sodium dodecyl | Pass, Grade 0 | Pass, Grade 1 |
| | benzene sulfonate) | | |
| E33 | 0.25 wt. ‰ anionic (sodium dodecyl | Pass, Grade 0 | Pass, Grade 1 |
| | benzene sulfonate) | | |
| E34 | 1.5 wt. ‰ anionic (sodium dodecyl | Pass, Grade 0 | Pass, Grade 1 |
| | benzene sulfonate) | | |
| E35 | 1 wt. ‰ Nonionic, alcohol ethoxylate, | Pass, Grade 0 | Pass, Grade 1 |
| | C8-12, 6-9 EO | | |
| CE20 | 2 wt. ‰ Nonionic, alcohol ethoxylate, | Pass, Grade 0 | Fail, Grade 2 |
| | C8-12, 6-9 EO | | |
| E36 | 0.5 wt. ‰ Nonionic, alcohol | Pass, Grade 0 | Pass, Grade 1 |
| | ethoxylate, C8-12, 6-9 EO | | |

It can be observed that suitable surfactant is beneficial for good pH 1+13.5 performance. Aromatic sulfonate based anionic including sodium dodecyl benzene sulfonate or dodecyl diphenyl ether sulfonate disodium salt when used at 0.1 wt. %-1.75 wt. %, nonionic surfactant alcohol ethoxylate, C8-12, 6-9 EO when used at 0.5-1% are benefit for passing pH 1+13.5 test. Or mixture of above anionic and nonionic surfactant is also suitable for ensuring good pH 1+13.5 test. In addition, surfactant will ensure a good appearance without gloss lost and dust after sealing process, heavy white dust observed on parts surface of CE19 after sealing. A suitable amount of surfactant within 0.1 wt. %-1.75 wt. % leads to a better corrosion resistance property.

What is claimed is:

1. A sealing solution kit comprising:
a) a medium temperature sealing solution; and
b) a high temperature sealing solution;
wherein the medium temperature sealing solution a), based on total volume of the medium temperature sealing solution, comprises: water; 0.6 to 2.6 g/L of fluoride ions; 2.0 to 5.0 g/L of a first ion selected from the group consisting of nickel ions, cobalt ions, chromium ions, cadmium ions and mixtures thereof; 0.03 to 1.3 g/L of a second ion selected from the group consisting of zirconium ions, titanium ions, silicon-containing ions, and mixtures thereof; an effective amount of surfactant; and
wherein the high temperature sealing solution b) comprises, based on a total volume of the high temperature sealing solution: water and 0.1 g/L to 100 g/L of water-soluble polymer, the water-soluble polymer having a weight-average molecular weight of 5,000 g/mol to 400,000 g/mol, and the water-soluble polymer being selected from the group consisting of poly(meth)acrylic acid and its derivatives, polyether and its derivatives, polyamide and its derivatives, poly(sulfonic acid) and its derivatives and mixtures thereof.

2. The sealing solution kit according to claim 1, wherein the poly(meth)acrylic acid derivatives comprise poly((methyl)acrylic acid), poly(acrylic acid) sodium salt, poly(methacrylic acid) ammonium salt, poly(vinyl acetate), acrylic acid-2-acrylamino-2-methylpropane sulfonic acid copolymer and other acrylic polymer.

3. The sealing solution kit according to claim 2, wherein the poly(meth)acrylic acid and its derivatives have a weight-average molecular weight of 5,000 g/mol to 100,000 g/mol.

4. The sealing solution kit according to claim 1, wherein the polyether derivatives comprise poly(ethylene oxide) and/or polyethylene glycol.

5. The sealing solution kit according to claim 4 wherein the polyether and its derivatives have a weight-average molecular weight of 80,000 g/mol to 400,000 g/mol.

6. The sealing solution kit according to claim 1, wherein the polyamide derivatives comprise polyacrylamide, poly(N-vinyl acetamide) and other amide polymers.

7. The sealing solution kit according to claim 6, wherein the polyamide and its derivatives have a weight-average molecular weight of 8,000 g/mol to 100,000 g/mol.

8. The sealing solution kit according to claim 1, wherein the poly(sulfonic acid) derivatives comprise poly((vinyl)sulfonic acid) sodium salt, polyacrylamidomethylpropane sulfonic acid, poly(styrenesulfonic acid), poly(styrenesulfonic acid) sodium salt and other sulfonic polymer.

9. The sealing solution kit according to claim 8 wherein the poly(sulfonic acid) and its derivatives have a weight-average molecular weight of 100,000 g/mol to 300,000 g/mol.

10. The sealing solution kit according to claim 1, wherein pH value of the high temperature sealing solution is 7 to 12.

11. The sealing solution kit according to claim 1, wherein the pH value of the high temperature sealing solution is 7.1 to 12.

12. The sealing solution kit according to claim 1, wherein concentration of the water-soluble polymer is 0.1 g/L to 20 g/L.

13. The sealing solution kit according to claim 1, wherein the surfactant is selected from anionic surfactants, non-ionic surfactants, ampholytic surfactants and mixtures thereof with a concentration of 0.1 wt. %-1.75 wt. % based on total amount of the medium temperature sealing solution.

14. The sealing solution kit according to claim 1, wherein the first ion is divalent nickel ion present in a concentration of 2.1 to 5.0 g/L.

15. The sealing solution kit according to claim 1, wherein the second ion is zirconium ion present in a concentration of 0.05 to 1.2 g/L.

16. The sealing solution kit according to claim 1, wherein concentration of the fluoride ion in the medium temperature sealing solution is from 0.7 to 2.4 g/L.

17. The sealing solution kit according to claim 1, wherein pH of the medium temperature sealing solution is from 4.5 to 7.

18. A method for sealing an anodized aluminum alloy surface with the sealing solution kit according to claim 1, comprising steps of:
a) contacting an anodized aluminum alloy surface with the medium temperature sealing solution at a temperature from 50 to 95° C. and a pH value of 4.5 to 7; and
b) contacting the anodized aluminum alloy surface with the high temperature sealing solution at a temperature from greater than 80° C. to no less than 100° C. and a pH value of 7 to 12;
c) drying a liquid layer formed in steps (a) and (b) to form a treated surface.

19. An article having at least one portion that comprises the treated surface of claim 18.

20. The article of claim 19, wherein said treated surface has corrosion resistance properties characterized by no appearance change when subjected to pH 1 and pH 13.5 test (TL 182 2012) at 20-23° C. each for 10 minutes separately.

21. A vehicle comprising the article of claim 19 as automotive part.
